(19) United States
(12) Patent Application Publication
(10) Pub. No.: US 2006/0293788 A1
(43) Pub. Date: Dec. 28, 2006

(54) Robotic floor care appliance with improved remote management

(76) Inventor: Pavel Pogodin, San Mateo, CA (US)

Correspondence Address: PAVEL POGODIN, ESQ., 617 NORTH DELAWARE STREET, SAN MATEO, CA, 94401, US

(21) Appl. No.: 11/167,675

(22) Filed: Jun. 26, 2005

(51) Int. Cl. G06F 19/00

(52) U.S. Cl. 700/245; 701/23

(57) ABSTRACT

A robotic floor care appliance with flexible web-enabled scheduling and status information/diagnostics systems. The robotic floor care appliance is supplied with a wireless network interface unit, which enables the appliance to establish network connections with remote network entities. The appliance may be provided with web and/or e-mail server(s) to enable the user to easily access the status/diagnostic information of the appliance and to furnish scheduling information to the appliance via various web-enabled protocols. The status/diagnostic information may be displayed to the user as a web page or sent to the user via e-mail. The scheduling information may be received from the user and transmitted to the appliance via HTTP protocol. The appliance may use web or e-mail connections to automatically notify the user of the status of the cleaning supplies, presence of malfunctions, if any, and the need for service. The appliance may also send the performance information to the manufacturer, which can be used to diagnose performance problems, create software patches, and to improve design of future products. Finally, the appliance may automatically download control software updates via a network connection.

### FIELD OF THE INVENTION

The present invention generally relates to the robotic floor care appliances and more specifically to managing robotic floor care appliances in a remote manner.

### DESCRIPTION OF THE RELATED ART

Several vendors offer robotic floor care appliances of varying types, including vacuum cleaners and liquid solution-based floor scrubbers. The aforementioned robotic floor care appliances will be referred to herein as such, and as “robotic appliances” or simply “appliances.” The robotic appliances perform the floor care operations with minimal human participation, autonomously guiding themselves along the floor surface.

The operation of most robotic floor care appliance is controlled by one or more microprocessors, which send control commands to the drive unit of the appliance based on the readings from one or more of sensors installed in the appliance. The drive unit typically consists of a set of one or more electric motors. Another set of motors may be utilized to operate brushes and the vacuum suction device of the appliance. Once the appliance hits an obstacle, the microprocessor receives the signals from the sensors and directs the driving motors to change the direction of the motion of the appliance.

In the existing devices, to start the operation of the robotic floor care appliance, such as a vacuum cleaner, the owner must manually activate an appropriate control located on the device itself. In some models, the owner is provided with a remote control unit, which may be activated for the appliance to start its operation. After the appliance has been activated in the described manner, the microprocessor unit of the appliance takes over the control of the appliance and continues to control it through the cleaning operation.

Both of the above methods suffer from two major flaws. In both cases, there is no facility provided for scheduling the operation of the appliance at a future time. In addition, the operator of the appliance must be present in the immediate vicinity of the appliance in order to manage it. Furthermore, the specialized remote controls of the existing robotic appliances are complex and difficult to use.

Thus, the existing methods for controlling robotic floor care appliances are deficient in their ability to provide for an easy and efficient remote management of the robotic device. The existing techniques also do not provide for ability to easily schedule future floor maintenance operations to be performed by the robotic appliance in a periodic and non-periodic manner.

### SUMMARY OF THE INVENTION

The present invention is directed to methods and systems that substantially obviate one or more of the above and other problems associated with conventional techniques for managing the robotic floor care appliance.

One aspect of the inventive concept is a method, computer programming product and computer system for flexible managing of a robotic floor care appliance.

Another aspect of the inventive methodology is a robotic floor care appliance with an advanced internal control algorithm and a flexible remote management.

Yet another aspect of the inventive methodology is a robotic floor care appliance with an event notification capability.

A further aspect of the inventive methodology is a robotic floor care appliance with advanced set of sensors and information analysis capabilities.

A further aspect of the inventive methodology is a robotic floor care appliance with advanced human interaction capabilities.

Additional aspects related to the invention will be set forth in part in the description which follows, and in part will be obvious from the description, or may be learned by practice of the invention. Aspects of the invention may be realized and attained by means of the elements and combinations particularly pointed out in the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of an inventive concept;

FIG. 2 illustrates another aspect of an exemplary embodiment of an inventive concept;

FIG. 3 shows a block-diagram illustrating the method of operation of the robotic floor care appliance;

FIG. 4 shows a block-diagram illustrating another aspect of the method of operation of the robotic floor care appliance;

FIG. 5 illustrates an exemplary embodiment of a floor care scheduling input form in accordance with the inventive concept; and

FIG. 6 illustrates an alternative exemplary embodiment of a floor care scheduling input form in accordance with the inventive concept.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific implementations consistent with principles of the present invention. These implementations are described in sufficient detail to enable those skilled in the art to practice the invention and it is to be understood that other implementations may be utilized and that structural changes may be made without departing from the scope and spirit of present invention. The following detailed description is, therefore, not to be construed in a limited sense.

The inventor recognized that would have been advantageous to schedule floor caring operation of the robotic appliance via a simple computer-based user interface in advance for the periods of time when the owner of the appliance would be away (i.e. at work) and would not interfere with the floor care operation. The inventor further recognized that the existing systems did not provide such scheduling flexibility.

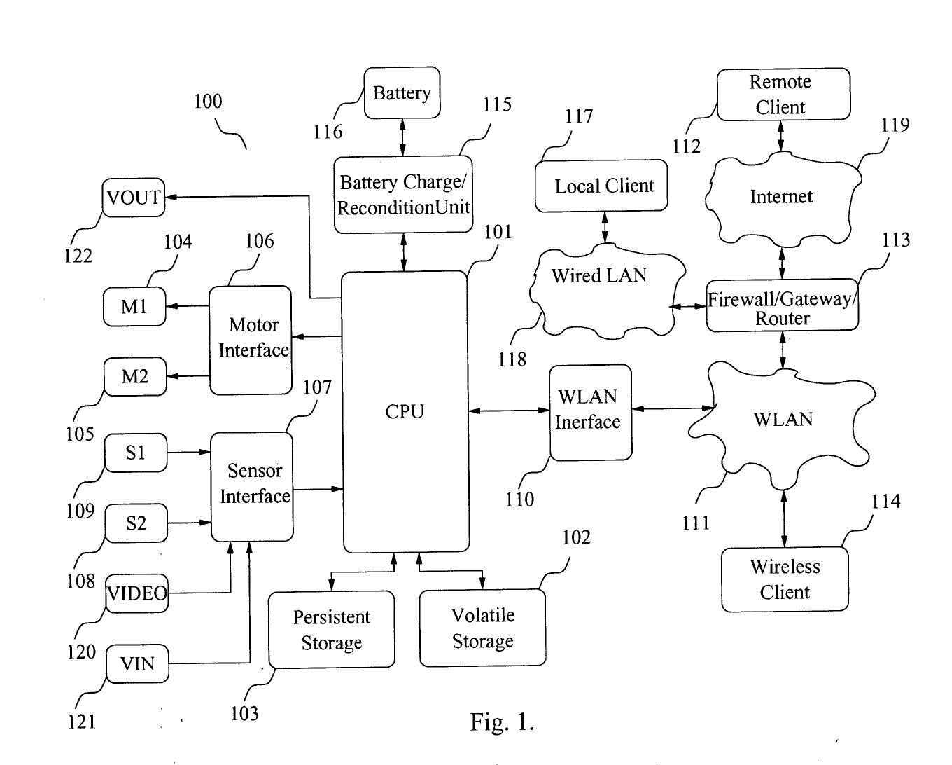

FIG. 1 shows an exemplary embodiment of the inventive control system of a robotic floor care appliance 100. The operation of the appliance shown in FIG. 1 is controlled by central processing unit (CPU) 101. Specifically, the operating control program of the appliance is stored in persistent storage 103. The operating program may be recorded in persistent storage 102 at the factory. The volatile storage 102 is provided for operation of the CPU 101 and stores intermediate variables and commands. In another embodiment, the volatile storage 102 is a part of the CPU 101.

The CPU 101 controls the operation of the motors 104 and 105 of the appliance by sending control commands through the motor interface 106. The aforementioned commands may include start motor command, stop motor command and command to set the value of the current or voltage flowing through the specific motor to a predetermined value.

It should be noted that the exact number of the controlled motors of the robotic appliance is not essential to the present invention. Additional motors not shown in the FIG. 1 may be provided. For example, one or more of the controlled motors may facilitate the motion of the appliance across the floor surface. Another motor may provide the suction necessary for the vacuum cleaner operation. Yet another controlled motor may actuate the floor agitator (i.e. rotating brush), etc. The CPU 101 may control the current flowing through the various motors so that the aggregate current does not exceed the output current capacity of the battery 116. When the battery change depletes, the CPU 101 may adjust the current flowing through some motors but not others. For example, upon detection of the battery discharge below a specific threshold, the CPU may reduce the current flowing through the drive motor(s) but not through the suction motor(s) in order to preserve the cleaning ability of the robotic appliance. Alternatively, the CPU may command the appliance to totally shut down the floor care operation and apply the entire remaining power to the drive unit so that the appliance can reach the home base and start re-charging its power source. After the re-charge is complete, the CPU may instruct the robotic appliance to resume the interrupted cleaning operation.

In an alternative implementation of the invention, the motor interface 106 is combined in the same physical packaging as the CPU 101.

During the operation of the robotic appliance, the CPU 101 receives the information from the sensors 108, 109, 120 and 121 through the sensor interface 107 of FIG. 1. As with the controlled motors, additional sensors (not shown) may be provided and the sensor interface 107 may be combined with the CPU 101. The sensor set may include an impact sensor for sensing when the robotic appliance runs into an obstacle. Upon an impact, a sensor would transmit a signal to the CPU 101, which, in response, would command the drive motors to change the direction of the motion of the appliance in accordance with the stored appliance operating software program.

Additional sensors may provide the CPU 101 with the information on the fullness of the dust bag of the appliance, the amount of remaining and/or used cleaning fluid, the status of the battery, including remaining power and remaining battery life, the type of the floor surface, the condition of the floor, presence of the dust, etc. Additional sensors may be provided for detecting malfunctions of various components of the appliance. Yet additional sensors may include microphone(s) and/or motion sensor(s). The microphones may be used to transmit live audio signal from the appliance to the client computer, while the motion sensor(s) may be used to determine if the room where the appliance is located is occupied. For example, the operating program of the appliance may be configured to pause the floor care operation if motion is detected in the room. The appliance may also be configured to start or resume operation if the room becomes unoccupied, as determined based on the motion sensor reading. In one embodiment of the invention, more than one motion sensor is used to facilitate the improved motion detection. For live audio transmission, any suitable audio streaming network software may be used in connection with the robotic appliance.

All the information received from the sensors may be analyzed by the CPU 101 in accordance with the stored operating program and, if necessary, the information may be further stored in the volatile and/or persistent storage 102 and 103, respectively for later use.

In the embodiment of the appliance 100 shown in FIG. 1, the sensor 120 is a video camera, which transmits a live video signal from the appliance for subsequent communication to the client computer via wireless network 111. Any existing video streaming algorithms (streaming MPEG, etc.) may be used for this purpose, and a software installed on the appliance may include one of the known or specially design web streaming video server applications. One exemplary streaming server application is CamServ, well-known to persons of skill in the art. In one embodiment of the invention, the video signal displayed to the user on the client computer is used by the user of the appliance for controlling the appliance's drive unit with the purpose of driving the appliance across the floor. To facilitate the driving operation, the client computer may be provided with a joystick, touchpad, mouse, or other similar control unit suitable for effective motion control. Alternatively, the video signal may be used by the CPU 101 for guiding the appliance during its floor care operation.

In the shown embodiment, the sensor 121 is a voice sensor, which is capable of receiving and decoding voice commands from the user. One example of such a voice sensor is a microphone coupled with an analog-to-digital converter for digitizing the input audio signal. This digitized signal may be further processed, for example, by undergoing frequency analysis prior to being fed into the CPU 101. To facilitate the voice command recognition, the software installed in the appliance may include any one of the well-known speech recognition algorithms.

The embodiment of the FIG. 1 also includes an output speech interface 122, which enables the robotic floor care appliance to create speech effects for audio communication with the user. For example, the appliance may indicate to the user in an audible manner when the connection to the network has been achieved. In addition, the appliance may acknowledge that it received and successfully processed the user's voice commands. Moreover, the appliance may signal in an audible manner that the user's command(s) was not properly understood by the appliance.

Based on the information received from the sensors, the CPU 101 controls the operation of the robotic appliance, including the direction and speed of the drive unit.

The battery 116 provides electric power to the robotic appliance 100 during its autonomous floor care operation. Time to time, the battery 116 needs to be recharged. To this end, there may be provided a docking and charging station (not shown), where the appliance can come for recharging. When the appliance is docked at the charging station, the battery 116 is charged by means of the battery charge and recondition unit 115. This unit is controlled by the CPU 101 to ensure the optimal charging conditions of the battery 116. To this end, during the autonomous operation of the appliance, the CPU 101, through a set of sensors constantly monitors the voltage and current provided by the battery 116 to determine its current operating condition. The information on the condition of the battery 116 is being periodically written by the CPU 101 to the volatile and/or persistent storage 102 and 103, respectively. When the appliance is in battery charging mode, the CPU 101 retrieves the previously stored battery condition data from the storage units 103 and/or 104 and uses these data to determine the optimal charging parameters for the battery, such as optimal charge current and/or voltage, as well as charge time. In one embodiment of the invention, the CPU 101 may direct the battery charge and recondition unit 115 to vary the charge current and/or voltage of the battery 116 during the charging operation in accordance with specific algorithms, well known in the art.

The communication with the robotic appliance 100 is accomplished through the wireless network interface 110, which connects the appliance 100 with the wireless network 111. The accessibility of the robotic appliance as a network entity using a network connection provides flexible means for controlling the appliance and for accessing the variety of its status and diagnostic information.

The network interface 110 may be of any known wireless interface types, including, without limitation Bluetooth, IEEE 802.11a, IEEE 802.11b, IEEE 802.11g, etc. A variety of other well-known networking communication protocols may be utilized. The appliance 100 may additionally be provided with the wired networking interface (not shown) for connection to the home or office wired network. For example, 10/100TX network interface can be used. The network connection may be affected by the user of the appliance manually, such as by inserting a network cable into, for example, an RG45 socket provided in the appliance. Alternatively, the network connection may be accomplished automatically, when the appliance is docked with the docking station. To this end, the appliance and the docking station may be provided with a set of mechanical/electrical contacts, which would mechanically engage upon docking, establishing an electrical connection.

The user of the robotic appliance 100 may access the appliance's information and command interface using any one of network clients 112, 114 and 117, which may be remote with respect to the appliance. To this end, many types of known networking configurations may be used in connection with the inventive robotic appliance. In one example, a user (owner) of the appliance may access its information and command interface using a client connected to the wireless network 114. In one embodiment of the invention, the client 114 is a computer embodying pre-installed client software coupled to the wireless network 111 using a wireless network interface card. One example of the client software is a web browser, such as Microsoft Internet Explorer, Netscape Navigator or Mozilla Firefox. Generally, the client 114 may be any hardware and software combination with direct access to the wireless network 111. As would be undoubtedly appreciated by those of skill in the art, an operating system, such as Windows, Linux of Mac OS is generally required in order for the aforesaid client software to be executed on a hardware platform.

In an alternative configuration, the local network client 117 is connected to the local wired network 118. This network is coupled to the wireless network 111 through the wireless Firewall/Gateway/Router 113, such that the client 117 can establish a network connection with the appliance 100 by means of the wireless network interface 110. An example of such wired network could be a house-wide network, which can be used to access the appliance.

Finally, the appliance may be accessed by remote clients 112 located anywhere on the Internet 119. To this end, the wireless network 111 is coupled to the Internet 119 by means of the Firewall/Gateway/Router 113. In one embodiment of the invention technique, the appliance 100 is assigned a predetermined port number by the Firewall/Gateway/Router 113, which routes all external network connection requests specifying the designated port number to the appliance 100. Thus, the appliance may be accessed from outside the local network by specifying the appropriate IP address of the local network and the port number assigned to the appliance by the Firewall/Gateway/Router 113. As will be appreciated by those of skill in the art, the inventive technique provides a great flexibility in controlling the robotic appliance.

As will be appreciated by those of skill in the art, the illustrated network topographies are illustrative only and various other network configurations may be utilized for remote access of the appliance. Clients 112, 114 and 117 may be of any known type, including personal (desktop) computers, notebook computers, personal digital assistants (PDAs), mobile phones, etc. Any type of device which provides the requisite network connectivity may be utilized as a client for purpose of managing the robotic floor care appliance. The clients may be running under a variety of operating systems, including, without limitation, Microsoft Windows, MacOS, Unix, PalmOS, etc. The information and command interface of the appliance displayed to the user by means of the client(s) may enable the user to remotely drive the appliance across the floor, by transmitting the user commands through the network to the CPU 101 and subsequently to the drive unit of the robotic appliance.

In one embodiment of the invention, the information and control interface of the appliance is displayed on the Bluetooth-enabled personal digital assistant (PDA) or a mobile phone.

In one embodiment of the invention, when a user accesses the robotic appliance 100 via any one of the network clients 112, 114 and 117, the information and command interface of the appliance is provided to the user in a form of one or more web pages displayed to the user by means of a web browser. Firstly, the displayed pages may contain status information of the appliance. The status information displayed on the client system may include the amount of the floor care supplies (such as cleaning fluid) remaining in the appliance, the amount of dust and/or waste water in the internal container(s) of the appliance, as well as the battery charge status. Additional displayed information may include the remaining useful life of the battery before replacement, as well as information on the malfunctions, if any, of the various components of the appliance.

Additionally, the displayed web pages may contain various information input forms, such as HTML forms, for inputting various control parameters from the user. For example, the user may input the floor caring operation schedule for the appliance 100 or upload software updates thereto.

The robotic floor care appliance may include additional or alternative components and units. Such additional components and units are described in U.S. Pat. No. 6,883,201, the disclosure of which is incorporated by reference herein in its entirety.

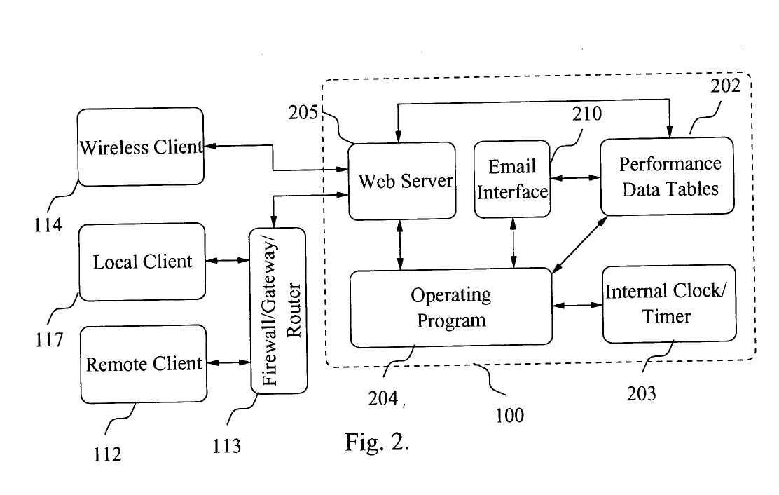

FIG. 2 illustrates the interaction of various functional software and hardware components of the floor care appliance 100. Specifically, the appliance 100 operates under control of an operating program process 204, which is being executed by the CPU 101. The operating program 204 controls motion direction and speed of the appliance, monitors the readings of the various sensors and periodically writes the performance characteristics of the appliance into the performance data tables 202. Additionally, the operating program 204 monitors the internal clock/timer 203 and compares its reading with the floor care schedule of the appliance stored in the persistent storage 103. Based on the results of the comparison, the operating program 204 starts and stops the floor care operation of the appliance.

The remote access to the appliance is accomplished through the web server process 205 and/or email interface process 210, both of which are also executed by the CPU 101. In one embodiment of the invention, the web server 205 responds to the external requests from clients 112, 114 and 117 by providing the clients with the information and command interface page of the appliance in a web-enabled document format, such as HTML. The communication between the web server and the clients may be accomplished in accordance with the HTTP protocol. As would be appreciated by those of skill in the art, other alternative protocols may be used for such communication. The appliance's network communication with the wireless client 114 is accomplished directly through the local wireless network, while the local and remote clients 117 and 112 access the appliance through the Firewall/Gateway/Router 113.

Upon request from one of the clients 112, 114 and 117, the operating program may access the stored performance data 202 and furnish it to the requesting clients through the web server and the e-mail interface 205 and 210, respectively. Alternatively, the web server and the e-mail interface may access the performance data tables directly. Also in response to the request from the client, the operating program may furnish the readings of the sensors of the appliance, as well as other information on its current state and past performance.

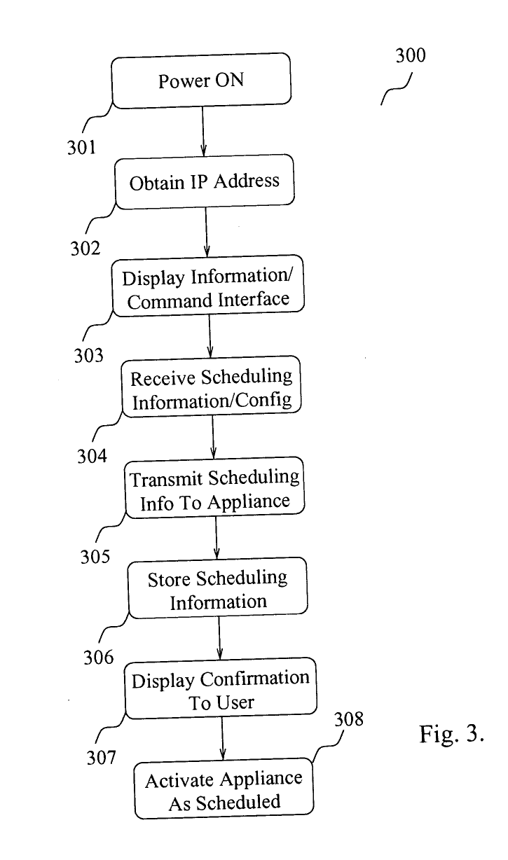

FIG. 3 illustrates an exemplary method of operation of the appliance. Once powered on at step 301, the appliance requests and receives an IP address from the wireless network 111, step 302. Once the IP address is obtained, the external clients are able to communicate with the appliance over the wireless network.

In response to a request from one of the clients 112, 114 and 117, the appliance returns to the requesting client the information and control interface screen in a form of a web page, step 303. Using this interface, the user of the appliance inputs various configuration parameters for the appliance, including the scheduling information for the floor care operation of the appliance, step 304. Additional information input by the user may include various event notification settings such as user's e-mail address, the specific events to be notified as well as the manner of the notification. For example, the user may configure the appliance to notify the user via e-mail when the cleaning supplies in the appliance run below a predetermined threshold, when the dust and/or waste water container becomes full, of when the battery needs replacement. The user may also configure the appliance to periodically email the user the status and past performance information on the appliance, such as duration and the amount of dust collected during the lest floor care operation.

Once the user inputs the scheduling information and the other configuration parameters, the client transmits this information via a web protocol to the appliance, see block 305. Once received by the appliance, the scheduling information and other configuration parameters are stored in the persistent storage 103, see step 306.

After that, the appliance displays an acknowledgement page on the client confirming to the user that the scheduling and the configuration parameters have been successfully updated. Thereafter, the appliance proceeds to operate in accordance with its pre-programmed operating program and the received configuration parameters, step 308.

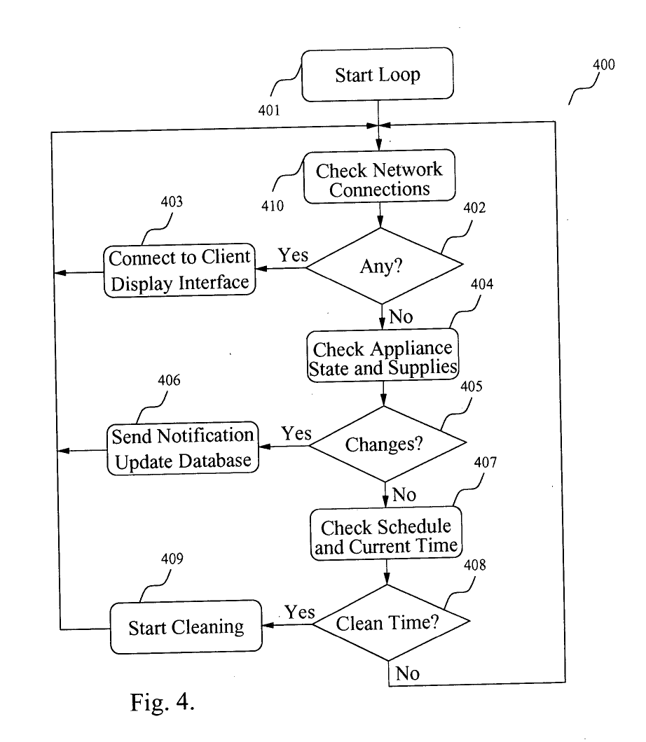

FIG. 4 shows a block-diagram illustrating an exemplary event processing loop 400 of the robotic appliance. After the start at step 401, the appliance checks for the presence of network connection requests from clients at step 410. If the appliance determines that the requests are present, it establishes the connection with the client and provides the client with the information and command interface of the appliance at step 403. After the connection is established, the appliance returns to the normal operation.

The appliance then checks for the its operating state, the presence and the amount of the remaining floor care supplies and/or the remaining capacity of the dust and/or waste fluid container at step 404. If any condition that requires further action is detected, the appliance updates its performance database and sends notification(s) to the user at step 406. Finally, the appliance checks the current time against its stored floor cleaning schedule at 407. If the schedule indicates that it is time to start or stop the floor cleaning operation, the appliance performs the scheduled action at step 409. After performing the appropriate action, the loop 400 returns to the routine operation.

The exact order of processing of the events is not essential to the inventive concept. Moreover, one or more of the specific event handling segments of the processing loop 400 may be implemented in a form of a separate daemon process running in the background and listening for the specific type of event. Once the event is detected, the daemon may pass the event information to the operating program 204, which would take the appropriate action. Various well-known methods for inter-process communication may be used for this purpose. The use of the daemon processes for event handling is well known to persons of skill in the art.

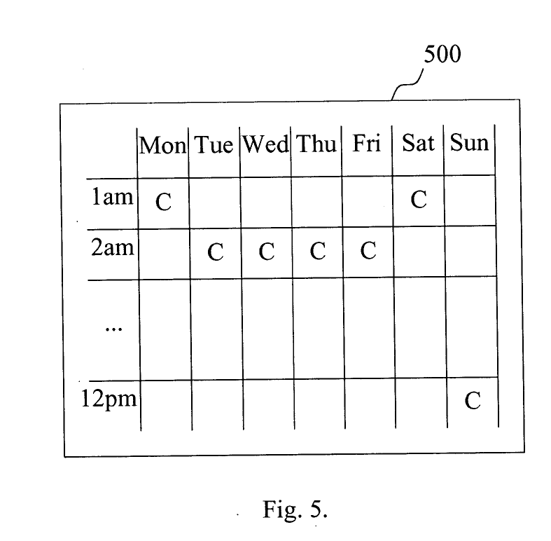

FIG. 5 illustrates an exemplary embodiment 500 of a floor care scheduling input form in accordance with the inventive concept. The columns of the form 500 in FIG. 5 represent weekdays, while the rows correspond to the time of day. The user schedules the floor care operation for a particular time of a particular day by selecting a box at the intersection of an appropriate row and column in the form 500. In one implementation, the scheduling form covers one week and the floor care operation is conducted regularly thereafter according to the same schedule each week, until the schedule is subsequently adjusted.

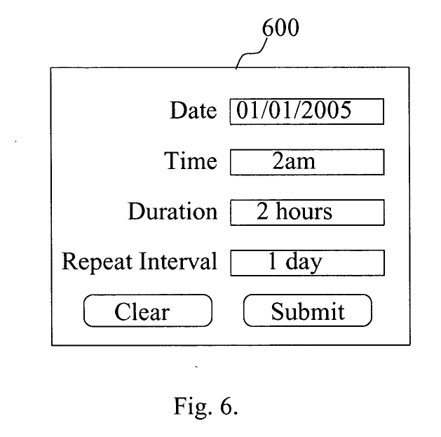

FIG. 6 illustrates an alternative exemplary embodiment 600 of a floor care scheduling input form in accordance with the inventive concept. In this embodiment, the user may specify the date, time and duration of the floor care operation, as well as the time period after which the floor care operation is repeated. For example, the user may specify that the floor care operation should take place weekly starting on a specific date and time. Alternatively, the user may schedule one-time cleaning without the repeat feature.

In an embodiment of the inventive appliance, when the amount of the floor care supplies in the appliance drops below a predetermined threshold value, when the internal dust/waste water container in the appliance becomes full, or when the appliance otherwise needs service, it may alert the user of the problem. This can be accomplished in a variety of ways. In one embodiment of the invention, the appliance, through the network 111, activates a software program on a client computer, which alerts the user. For example, the program may display a pop-up window with an appropriate message. Alternatively or additionally, the appliance may send an e-mail message to the user by means of the e-mail interface 210. To this end, the user would program the appliance with the user's e-mail address during the initial setup of the appliance.

In an embodiment of the inventive system, the CPU 101 collects information on performance and malfunctions of various components of the appliance 101 and provides the collected information to the manufacturer via network connection. For example, various performance stats may be furnished to the manufacturer via e-mail by means of e-mail interface 210. The manufacturer may use received information for designing replacement components, future products or software updates.

In another embodiment, when the user contacts the manufacturer's service center for technical support of the appliance, the appliance furnishes its diagnostic information to the support specialist for instant remote diagnostics of the problem(s). To that effect, the support specialist may access the appliance's information and control interface via remote client 112. In addition, the support technician may use the aforesaid interface to install software updates. This feature of the inventive appliance greatly simplifies the technical support and diagnostics thereof.

In another embodiment of the inventive appliance, the appliance may automatically download and install various software updates. To this end, the appliance would time-to-time query a predetermined web location for software update information. Once the availability of the update is detected by the appliance, the appliance would proceed with the download and installation of the software. The download may be done using any known web protocol such as HTTP or FTP. Once downloaded and installed, the updated software would be stored in the persistent storage 103 of the appliance. In another embodiment, the software download and update would be triggered by the user through the described information and command interface of the appliance.

Follows is a description of various operating modes of the inventive floor care appliance.

### Restart After Recharge Operating Mode

If during the floor care operation the CPU 101 detects that the remaining power capacity of the battery is below a predetermined threshold, it may instruct the appliance to interrupt the color care operation and proceed to the home base for recharging. In the “restart after recharge” operating mode, the appliance resumes the floor care after the recharge has been completed and the power capacity has been restored.

### Scheduled Cleaning Operating Mode

In the “scheduled cleaning” operating mode, the appliance performs a one-time floor care operation at a specific scheduled time.

### Regular Cleaning Operating Mode

In the “regular cleaning” operating mode the appliance performs periodic floor care operation in accordance with the stored schedule information. The scheduled periodic intervals may be as short as a few hours and as long as weeks or even months.

### Clean Floor Operating Mode

In the “clean floor” operating mode, the appliance constantly monitors the condition of the floor and performs the cleaning operation until the required condition is achieved. If necessary, the appliance may interrupt the floor care operation and proceed to recharge its energy source. After the completion of the recharging, the appliance may resume the floor care.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

It should be noted that the robotic appliance may be of any known type, including a robotic vacuum cleaner describer in U.S. Pat. No. 6,883,201, the disclosure of which is incorporated by reference herein in its entirety, or a floor washing robotic appliance, which treats the floor with a washing fluid. Other types of robotic appliances may be used, including, for example, a floor waxing or polishing appliance.

Moreover, other implementations of the invention will be apparent to those skilled in the art from consideration of the specification and practice of the invention disclosed herein. Various aspects and/or components of the described embodiments may be used singly or in any combination in the robotic floor care appliance. It is intended that the specification and examples be considered as exemplary only, with a true scope and spirit of the invention being indicated by the following claims.

What is claimed is:

1. A method for managing a robotic floor care appliance, the robotic floor care appliance comprising a drive unit and a control unit, the control unit comprising a central processing unit, a storage unit, a network interface unit and a plurality of sensors, the robotic floor care appliance being managed by a user accessing a client computer connected to a network, the method comprising:
establishing a network connection between the robotic floor care appliance and a client computer through the network using the network interface unit;
transmitting a first information from the floor care appliance to the client computer, the first information comprising a control interface of the robotic floor care appliance;
displaying the control interface on the client computer to the user;
receiving scheduling information from the user of the client computer using the displayed control interface of the floor care appliance;
transmitting the scheduling information from the client computer to the robotic floor care appliance via network;
receiving the scheduling information transmitted by the client computer by the robotic floor care appliance;
storing the scheduling information in the storage unit of the robotic floor care appliance; and
activating the robotic floor care appliance in accordance with the stored scheduling information.

2. The method of claim 1, wherein the transmitting further comprises sending information on the status of the robotic floor care appliance to the client computer.

3. The method of claim 2, wherein the status information comprises the information on the remaining capacity of the dust container of the robotic floor care appliance.

4. The method of claim 2, wherein the status information comprises the video signal from a video camera installed in the robotic floor care appliance.

5. The method of claim 1, wherein the network is a wireless network.

6. The method of claim 1, wherein the said establishing comprises receiving a network address for the robotic floor care appliance and establishing connection with a network entity designated by the received address.

7. The method of claim 1, wherein the displayed control interface comprises a web document.

8. The method of claim 1, wherein the control interface of the robotic floor care appliance is displayed on a web browser.

9. The method of claim 1, wherein the control interface of the robotic floor care appliance comprises a web form.

10. A robotic floor care appliance comprising:
a drive unit, the drive unit comprising at least one motor;
a power unit for supplying power to the robotic floor care appliance;
a control unit, the control unit comprising:
a central processing unit;
a data storage unit;
a network interface unit; and
a plurality of sensors;
wherein the data storage unit of the robotic floor care appliance embodies a software program, which causes the robotic floor care appliance to:
establish a network connection between the robotic floor care appliance and a client computer through a network using the network interface unit;
transmit a first information from the floor care appliance to the client computer for displaying to the user, the first information comprising a control interface of the robotic floor care appliance;
receive from the client computer scheduling information input by the user into the client computer;
store the scheduling information in the storage unit of the robotic floor care appliance; and
activate the robotic floor care appliance in accordance with the stored scheduling information.

11. The robotic floor care appliance of claim 10, wherein the first information further comprises the information on the status of the robotic floor care appliance.

12. The robotic floor care appliance of claim 11, wherein the status information comprises the information on the remaining capacity of the dust container of the robotic floor care appliance.

13. The robotic floor care appliance of claim 11, further comprising at least one video camera, wherein the status information comprises the video signal from the at least one video camera.

14. The robotic floor care appliance of claim 10, wherein the network is a wireless network.

15. The robotic floor care appliance of claim 10, wherein said establishing comprises requesting a network address for the robotic floor care appliance and receiving the requested network address.

16. The robotic floor care appliance of claim 11, wherein the control interface displayed to the user comprises controls for controlling the drive unit of the robotic floor care appliance.

17. The robotic floor care appliance of claim 11, wherein the network interface unit is a Bluetooth protocol compliant.

18. The robotic floor care appliance of claim 11, wherein the plurality of sensors comprises a voice sensor, and wherein the data storage unit of the robotic floor care appliance further embodies a voice recognition software.

19. A robotic floor care appliance comprising:
a drive unit, the drive unit comprising at least one motor;
a power unit for supplying power to the robotic floor care appliance;
a control unit, the control unit comprising:
a central processing unit;
a data storage unit;
a network interface unit; and
a plurality of sensors;
wherein the data storage unit of the robotic floor care appliance embodies a at least one event notification criteria and a software program, which causes the robotic floor care appliance to:
monitor at least one event, the at least one event comprising the status of the components of the floor care appliance;
establish a network connection between the robotic floor care appliance and a client computer through a network using the network interface unit; and
notify a user of the robotic floor care appliance via an established network connection of at least one event that satisfies the stored event notification criteria.

20. The robotic floor care appliance of claim 19, wherein the event notification criteria is input by the user of the robotic floor care appliance during its configuration.
